(19) United States
(12) Patent Application Publication
(10) Pub. No.: US 2024/0264033 A1
(43) Pub. Date: Aug. 8, 2024

(54) Method and Apparatus for Determining Mechanical Device Fault

(71) Applicant: YANTAI JEREH PETROLEUM EQUIPMENT & TECHNOLOGIES CO., LTD., Yantai (CN)

(72) Inventors: Xinmeng WANG, Yantai (CN); Zongwen WANG, Yantai (CN); Hongxing WANG, Yantai (CN)

(73) Assignee: YANTAI JEREH PETROLEUM EQUIPMENT & TECHNOLOGIES CO., LTD., Yantai (CN)

(21) Appl. No.: 18/640,286

(22) Filed: Apr. 19, 2024

Related U.S. Application Data
(63) Continuation of application No. PCT/CN2022/111885, filed on Aug. 11, 2022.

(30) Foreign Application Priority Data
Apr. 27, 2022 (CN) 202210452424.6

(51) Int. Cl. G01M 7/02; G06F 18/213; G06N 3/0442; G06N 3/08

(52) U.S. Cl. CPC G01M 7/025; G06F 18/213; G06N 3/0442; G06N 3/08

(57) ABSTRACT

A method and apparatus for determining a mechanical device fault are provided. The method includes: obtaining vibration data corresponding to a target test position of a device and a preset neural network model (S101); inputting the vibration data to the preset neural network model, and obtaining an output result of the preset neural network model (S102); determining a target label included in the output result, where the target label is either of a fault label and a non-fault label (S103); and determining, in a case that the target label is the fault label, that a fault occurs at the target test position; otherwise, determining that the fault does not occur at the target test position (S104). Therefore, the technical problem that a high-accuracy mechanical device fault detection means is lacked in the related art is resolved.

### CROSS-REFERENCE TO RELATED APPLICATIONS

This application is a continuation of and claims the benefit of priority to PCT International Application No. PCT/CN2022/111885, filed on Aug. 11, 2022, which is based on and claims the benefit of priority to Chinese Patent Application No. 202210452424.6, filed with the China National Intellectual Property Administration on Apr. 27, 2022, and entitled “METHOD AND APPARATUS FOR DETERMINING MECHANICAL DEVICE FAULT.” These prior patent applications are is incorporated herein by reference in their entireties.

### TECHNICAL FIELD

This application relates to the field of mechanical device operation status detection, and specifically, to a method and apparatus for determining a mechanical device fault.

### BACKGROUND

In the related art, mechanical device operation state detection and fault diagnosis are currently popular research directions. With the accumulation and storage of various types of data such as mechanical device operation data, various device fault prediction methods based on big data and data analytics also emerge, and various neural network models have been utilized. Some solutions are based on a laboratory environment and cannot simulate and be applied to a real on-site working environment affected by a plurality of factors. The existing modes are thus difficult for actual implementation. In addition, fault feature extraction can be a difficult task, which directly affects the accuracy of device fault prediction.

A vibration signal has been used in the industry as fault state response data commonly used in reciprocating or rotating mechanical devices. Ideally, such vibration signal could provide a signal response timely when a fault occurs. However, due to impact of on-site noise and impact of various conditions, such as on-site multi-working condition operations, a fault response in the vibration signal may not be apparent, or it may be difficult to perform fault feature extraction from such signal. In most currently existing researches, fault feature extraction is performed based on the vibration signal in various manners such as time domain statistical indicator extraction, frequency domain statistical indicator extraction, time-frequency domain joint distribution matrix extraction, signal decomposition, and fault prediction is usually performed in combination with various neural networks. However, the prediction accuracy is generally not high. In addition, the fault features are only reflected in a specific dimension, and short-time transient features of the fault and long-time decay and deterioration features of the fault cannot be captured comprehensively and timely.

No effective solution has been provided at present against the forgoing problems in the related art.

### SUMMARY

A main objective of this application is to provide a method and apparatus for determining a mechanical device fault, to resolve the technical problem that a high-accuracy mechanical device fault detection means is lacked in the related art.

To achieve the foregoing objective, according to an aspect of this application, a method for determining a mechanical device fault is provided. The method includes: obtaining vibration data corresponding to a target test position of a device and a preset neural network model; inputting the vibration data to the preset neural network model, and obtaining an output result of the preset neural network model; determining a target label included in the output result, where the target label is either of a fault label and a non-fault label; and determining, in a case that the target label is the fault label, that a fault occurs at the target test position; otherwise, determining that the fault does not occur at the target test position.

Further, before the obtaining a preset neural network model, the method further includes: constructing an initial preset neural network model, where the initial preset neural network model includes a plurality of convolution layers, a plurality of pooling layers, and a plurality of fully-connected layers, neural network layers are connected by a ReLU activation function, and the fully-connected layers connected to the initial preset neural network model are connected to a Log Softmax function; and determining a training data set used for training the initial preset neural network model, and training the initial preset neural network model based on the training data set to obtain the preset neural network model.

Further, the determining a training data set used for training the initial preset neural network model includes: obtaining source data, where the source data is acquired through a vibration sensor arranged on a mechanical device, and the source data is either of fault-type data and non-fault-type data; constructing, according to the source data, a 3D time-frequency joint distribution cube including a preset dimension, where the preset dimension includes at least a long-time domain dimension, a short-time domain dimension, and a frequency domain dimension; performing dimensionality-reduced feature extraction on the 3D time-frequency joint distribution cube to obtain a long short time-frequency difference (LST-FD) joint distribution matrix set; and dividing a plurality of LST-FD joint distribution matrices included in the LST-FD joint distribution matrix set to obtain the training data set and a test data set used for testing the preset neural network model.

Further, before the dividing a plurality of LST-FD joint distribution matrices included in the LST-FD joint distribution matrix set to obtain the training data set and a test data set used for testing the preset neural network model, the method further includes: determining a label type corresponding to the LST-FD joint distribution matrix according to a source data type corresponding to the LST-FD joint distribution matrix, where the label type is either of the fault label and the non-fault label.

Further, the constructing, according to the source data, a 3D time-frequency joint distribution cube including a preset dimension includes: determining a first temporal granularity, and performing data segmentation on the source data based on the first temporal granularity to obtain a fault sample data set and a non-fault sample data set, where the fault sample data set includes a plurality of fault data subsets, the non-fault sample data set includes a plurality of non-fault data subsets, and the first temporal granularity includes at least a total time corresponding to a plurality of full rotation periods corresponding to the mechanical device; determining a second temporal granularity; segmenting each fault data subset according to the second temporal granularity to obtain a plurality of pieces of first short-time period data; segmenting each non-fault data subset according to the second temporal granularity to obtain a plurality of pieces of second short-time period data; and processing the plurality of pieces of first short-time period data corresponding to the fault sample data set and the plurality of pieces of second short-time period data corresponding to the non-fault sample data set, to obtain the 3D time-frequency joint distribution cube.

Further, the processing the plurality of pieces of first short-time period data corresponding to the fault sample data set and the plurality of pieces of second short-time period data corresponding to the non-fault sample data set, to obtain the 3D time-frequency joint distribution cube, includes: performing STFT transformation on the plurality of pieces of first short-time period data to obtain a plurality of first time domain joint distribution matrices; performing STFT transformation on the plurality of pieces of second short-time period data to obtain a plurality of second time domain joint distribution matrices; stacking the plurality of first time domain joint distribution matrices and the plurality of second time domain joint distribution matrices into a time domain joint distribution matrix set according to the first temporal granularity and a preset sequence; and constructing the 3D time-frequency joint distribution cube according to the time domain joint distribution matrix set.

Further, the performing dimensionality-reduced feature extraction on the 3D time-frequency joint distribution cube to obtain an LST-FD joint distribution matrix set includes: performing, based on the long-time domain dimension, dimensionality-reduced feature extraction on the 3D time-frequency joint distribution cube through a formula 1 to obtain the LST-FD joint distribution matrix, where the formula 1 is:

$$Fre\_d = \frac{[ ( z ( 2 , t , fre ) - z ( 1 , t , fre ) ) + … + ( z ( k , t , fre ) - z ( k - 1 , t , fre ) ) ] * 2}{k} ,$$

where z(k,t,fre) is a time-frequency joint distribution matrix in a long-time domain dimension of the k^{th} layer in the 3D time-frequency joint distribution cube, t is the short-time domain dimension corresponding to the 3D time-frequency joint distribution cube, and Fre_d is a frequency-time domain average difference obtained by performing frequency duplication and calculation by the 3D time-frequency joint distribution cube based on the long-time domain dimension.

Further, the preset neural network model is a 2D-CNN neural network model.

To achieve the foregoing objective, according to another aspect of this application, an apparatus for determining a mechanical device fault is provided. The apparatus includes: an obtaining unit, configured to obtain vibration data corresponding to a target test position of a device and a preset neural network model; an input unit, configured to input the vibration data to the preset neural network model, and obtain an output result of the preset neural network model; a first determining unit, configured to determine a target label included in the output result, where the target label is either of a fault label and a non-fault label; and a second determining unit, configured to determine, in a case that the target label is the fault label, that a fault occurs at the target test position; otherwise, determine that the fault does not occur at the target test position.

To achieve the foregoing objective, according to another aspect of this application, a computer-readable storage medium is provided. The computer-readable storage medium includes a stored program, where when run, the program controls a device in which the computer-readable storage medium is located to execute the method for determining a mechanical device fault according to any one of the example implementations above.

To achieve the foregoing objective, according to another aspect of this application, a processor is provided. The processor is configured to run a program, where when run, the program executes the method for determining a mechanical device fault according to any one of the example implementations above.

Through this application, the following steps are adopted: obtaining vibration data corresponding to a target test position of a device and a preset neural network model; inputting the vibration data to the preset neural network model, and obtaining an output result of the preset neural network model; determining a target label included in the output result, where the target label is either of a fault label and a non-fault label; and determining, in a case that the target label is the fault label, that a fault occurs at the target test position; otherwise, determining that the fault does not occur at the target test position. The technical problem that a high-accuracy mechanical device fault detection means is lacked in the related art is resolved, to achieve the technical effect of capturing and reflecting responses of vibration signals to a fault from a plurality of dimensions, so that not only transient features of the fault can be captured, but also long-time deterioration tendency features of the fault can be captured.

### BRIEF DESCRIPTION OF THE DRAWINGS

Accompanying drawings that constitute a part of this application are used for providing further understanding about this application. Exemplary embodiments of this application and descriptions thereof are used for explaining this application, and do not constitute a limitation on this application. In the accompanying drawings:

FIG. 1 is a flowchart of a method for determining a mechanical device fault according to an embodiment of this application;

FIG. 2 is a flowchart corresponding to another method for determining a mechanical device fault according to this application; and

FIG. 3 is a schematic diagram of an apparatus for determining a mechanical device fault according to an embodiment of this application.

### DETAILED DESCRIPTION

It should be noted that the embodiments in the present disclosure and features in the embodiments may be mutually combined as long as no conflict would occur. This application is described below in detail with reference to the accompanying drawings and the embodiments.

To make a person having ordinary skill in the art better understand the solutions of this application, the technical solutions in the embodiments of this application are described below with reference to the accompanying drawings in the embodiments of this application. The described embodiments are merely some rather than all of the embodiments of this application. Other embodiments that can be obtained or derived by a person of ordinary skill in the art based on embodiments of this application without creative efforts shall be considered as falling within the protection scope of this application.

It should be noted that in the specification, claims, and accompanying drawings of this application, the terms “first”, “second”, and so on are intended to distinguish between similar objects but do not necessarily indicate a specific order or sequence. It should be understood that such data used in this way can replace each other in an appropriate situation for describing the embodiments of this application herein. Moreover, the terms “include”, “include”, and any other variants thereof mean are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

According to an embodiment of this application, a method for determining a mechanical device fault is provided.

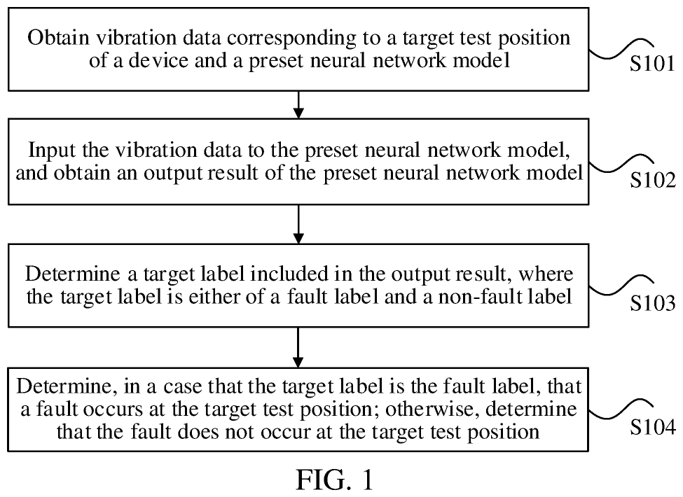

FIG. 1 is a flowchart of a method for determining a mechanical device fault according to an embodiment of this application. As shown in FIG. 1, the method includes the following steps:

Step S101: Obtain vibration data corresponding to a target test position of a device and a preset neural network model.

Step S102: Input the vibration data to the preset neural network model, and obtain an output result of the preset neural network model.

Step S103: Determine a target label included in the output result, where the target label is either of a fault label and a non-fault label.

Step S104: Determine, in a case that the target label is the fault label, that a fault occurs at the target test position; otherwise, determine that the fault does not occur at the target test position.

As stated above, this application provides a method for determining a mechanical device fault. Vibration data of a to-be-tested part of a device is input into a preset neural network model, and whether the to-be-tested part is faulty is determined based on a label output by the preset neural network model.

Through the foregoing method, the technical problem that a high-accuracy mechanical device fault detection means is lacking in the related art is resolved, to achieve the technical effect of capturing and reflecting responses of vibration signals to a fault from a plurality of dimensions (that are learned in the neural network model), so that not only transient features of the fault can be captured, but also long-time deterioration tendency features of the fault can be captured.

Specifically, in this application, vibration signals of the to-be-tested part are obtained mainly by installing a vibration sensor at a target detection position of the mechanical device, and vibration data is acquired and returned for storage through data acquisition software.

For example, in a process of predicting a fault of an input-end bearing of a reduction box (or reduction gear box) of an in-vehicle piston pump of a fracturing vehicle, a one-way acceleration vibration sensor may be installed in a horizontal direction of an input side of the reduction box (close to a position of the input-end bearing) to acquire vibration data. The sensor may be associated with an identifier, e.g., marked AI1-32. A sampling frequency of the sensor may be predetermined, e.g., at 51.2 KHz or may be configurable, and a rotation speed of a motor at a power end of the reduction gearbox may be preset or may be otherwise known.

In an example embodiment, in the method for determining a mechanical device fault provided in this embodiment of this application, before obtaining the preset neural network model, the method further includes: constructing an initial preset neural network model, where the initial preset neural network model includes a plurality of convolution layers, a plurality of pooling layers, and a plurality of fully-connected layers, which are connected by a ReLU activation function, and the fully-connected layers are further connected to a Log Softmax function; and determining a training data set used for training the initial preset neural network model, and training the initial preset neural network model based on the training data set to obtain the preset neural network model.

In an example embodiment, the preset neural network model may be a 2D-CNN neural network model. In the foregoing method, a 2D-CNN neural network model needs to be built first. A network structure of the 2D-CNN neural network model includes a total of 7 layers, including 3 convolution layers, 2 pooling layers, and 2 fully-connected layers. A Log Softmax function is connected between neurons by a ReLU activation function and finally the fully-connected layers, to output a model prediction result.

It should be noted that in an example embodiment, a CrossEntropyLoss function may be selected as a loss function of the network model to calculate an error between input data and the prediction result. In addition, an Adam function may be selected as an optimizer corresponding to the model to perform model neuron connection weight optimization.

As stated above, this application provides a method for determining a training data set of a preset neural network model, specifically including the following steps:

S201: Obtain source data, where the source data is acquired through a vibration sensor arranged on a mechanical device, and the source data is either of fault-type data and non-fault-type data.

S202: Construct, according to the source data, a 3D time-frequency joint distribution cube including preset dimensions, where the preset dimension includes at least a long-time domain dimension, a short-time domain dimension, and a frequency domain dimension.

S203: Perform dimensionality-reduced feature extraction on the 3D time-frequency joint distribution cube to obtain an LST-FD joint distribution matrix set.

S204: Divide a plurality of LST-FD joint distribution matrices included in the LST-FD joint distribution matrix set to obtain the training data set and a test data set used for testing the preset neural network model.

As stated above, this application provides a method for detecting a mechanical device fault based on an LST-FD matrix. The LST-FD matrix starts from two temporal granular dimensions of short time (transiency) and long time. A 3D time-frequency joint distribution cube is constructed in the long and short time dimensions, and time domain average difference calculation is performed on frequency signals in the long-time domain dimension. Feature values are extracted in a dimensionality reducing manner, to obtain the LST-FD matrix, which is used as a feature matrix of a preset neural network model for fault classification prediction to perform device fault classification prediction. Another long-time domain dimension is added to the LST-FD matrix based on the time-frequency joint distribution matrix, and dimensionality-reduced feature extraction is performed in this time domain dimension, so that time-frequency fluctuation features are amplified when a fault signal occurs, and two fault signals, namely, short-term transient feature responses of the device at an early stage of occurrence of the fault and long-term decay feature fluctuations, can be captured simultaneously, which, compared with a conventional time-frequency graph or another feature indicator as a model input, have higher prediction accuracy.

In an example embodiment, in the method for determining a mechanical device fault provided in this embodiment of this application, constructing, according to the source data, the 3D time-frequency joint distribution cube including the preset dimensions includes: determining a first temporal granularity, and performing data segmentation on the source data based on the first temporal granularity to obtain a fault sample data set and a non-fault sample data set, where the fault sample data set includes a plurality of fault data subsets, the non-fault sample data set includes a plurality of non-fault data subsets, and the first temporal granularity includes at least a total time corresponding to a plurality of full rotation periods corresponding to the mechanical device; determining a second temporal granularity; segmenting each fault data subset according to the second temporal granularity to obtain a plurality of pieces of first short-time period data; segmenting each non-fault data subset according to the second temporal granularity to obtain a plurality of pieces of second short-time period data; and processing the plurality of pieces of first short-time period data corresponding to the fault sample data set and the plurality of pieces of second short-time period data corresponding to the non-fault sample data set, to obtain the 3D time-frequency joint distribution cube.

Specifically, this embodiment of this application provides two temporal granularities, including a first temporal granularity and a second temporal granularity.

In a specific embodiment, according to a rotation speed of a power end of the device, sample data segmentation is performed on source data based on a temporal granularity t₁ (the first temporal granularity) (a length of the temporal granularity t₁ includes at least several, e.g., 10, full rotation period time lengths of the device), to obtain a fault data sample data set X__{fault}={x__{(f1,)}, x__{(f2,)}, . . . , x__{fi}} and a normal data sample data set X_ₙₒᵣₘₐₗ={x__{(n1,)}, x__{(n2,)}, . . . , x_ₙᵢ}, where x__{(f1,)} and the like are fault data subsets, and x__{(n1,)} is a non-fault data subset.

Further, a second temporal granularity t₂ is determined. Preferably, the second temporal granularity is determined according to a rotation period of the device, and generally covers one full rotation period time length of the device.

Data division is performed on the fault data subsets and the non-fault data subset according to the second temporal granularity, to obtain a plurality of pieces of first short-time period data and a plurality of pieces of second short-time period data. For example, the fault data subset x__{(f2,)} is divided into x__{(f2,)}{x__{(t21,)}, x__{(t22,)}, . . . , x_ₜ₂ₖ} according to the temporal granularity t₂, where k=t₁/t₂. The foregoing processing is performed on all the remaining pieces of sample data.

In an example embodiment, in the method for determining a mechanical device fault provided in this embodiment of this application, the processing the plurality of pieces of first short-time period data corresponding to the fault sample data set and the plurality of pieces of second short-time period data corresponding to the non-fault sample data set, to obtain the 3D time-frequency joint distribution cube, includes: performing STFT transformation on the plurality of pieces of first short-time period data to obtain a plurality of first time domain joint distribution matrices; performing STFT transformation on the plurality of pieces of second short-time period data to obtain a plurality of second time domain joint distribution matrices; stacking the plurality of first time domain joint distribution matrices and the plurality of second time domain joint distribution matrices into a time domain joint distribution matrix set according to the first temporal granularity and a preset sequence; and constructing the 3D time-frequency joint distribution cube according to the time domain joint distribution matrix set.

Further, the STFT transformation may be performed on the plurality of pieces of first short-time period data and the plurality of pieces of second short-time period data based on the second temporal granularity. The Hann window may be selected as a window function, a length of the window function may be, e.g., 256, and an overlap of the window function may be 50%. After the STFT transformation is performed, a time-frequency joint distribution matrix z_{(t, fre)} is obtained, where t is a time length, fre is a frequency range, and a median value of z is a frequency amplitude. For example, for x__{(f2)}={x__{(t21,)} x__{(t122,) . . .} , x_ₜ₂ₖ}, after the STFT transformation is performed, k time-frequency joint distribution matrices {z__{(x_t21,)}, z__{(x_t22,)}, z__{(x_t23,)}, . . . , z__{x_t2k}} are obtained. That is, in X__{(fault)}={x__{(f1,)}, x__{(f2,)}, . . . , x__{fi}} and X_₍ₙₒᵣₘₐₗ₎={x__{(n1,)}, x__{(f2,)}, . . . , x_ₙᵢ}, each piece of short-time period data generates k time-frequency joint distribution matrices.

Further, in the two data sets, X__{(fault)}={x__{(f1,)}, x__{(f2,)}, . . . , x__{fi}} and X_₍ₙₒᵣₘₐₗ₎={x__{(n1,)}, x__{(n2,)}, . . . , x_ₙᵢ}, for k time-frequency joint distribution matrices included in each data set, using k (that is, the time length t₂) as a third dimension, a 3D time-frequency joint distribution cube is constructed by stacking the k time-frequency joint distribution matrices in chronological order by t₂. That is, each piece of sample data in the foregoing two data sets corresponds to a 3D time-frequency joint distribution cube (k, t, fre). In the 3D time-frequency joint distribution cube, the first dimension is a vibration-signal long-time domain dimension (which includes at least 10 full rotation periods of the device), the second dimension is a vibration-signal short-time domain dimension (which covers one rotation period of the device), and the third dimension is a vibration-signal frequency domain dimension.

In an example embodiment, in the method for determining a mechanical device fault provided in this embodiment of this application, performing dimensionality-reduced feature extraction on the 3D time-frequency joint distribution cube to obtain the LST-FD joint distribution matrix set includes: performing, based on the long-time domain dimension, dimensionality-reduced feature extraction on the 3D time-frequency joint distribution cube through formula 1 to obtain the LST-FD joint distribution matrix, where formula 1 is:

$$Fre\_d = \frac{[ ( z ( 2 , t , fre ) - z ( 1 , t , fre ) ) + … + ( z ( k , t , fre ) - z ( k - 1 , t , fre ) ) ] * 2}{k} ,$$

where z(k,t,fre) is a time-frequency joint distribution matrix in a long-time domain dimension (the time dimension t₁) of the k^{th} layer in the 3D time-frequency joint distribution cube, t is the short-time domain dimension corresponding to the 3D time-frequency joint distribution cube, and Fre_d is a frequency-time domain average difference obtained by performing frequency duplication and calculation by the 3D time-frequency joint distribution cube based on the long-time domain dimension.

Further, dimensionality-reduced feature extraction is performed on the 3D time-frequency joint distribution cube obtained through construction based on the first dimension, e.g., the vibration-signal long-time domain dimension.

In other words, the frequency-time domain average difference Fre_d is calculated on amplitudes corresponding to frequency values at different short-time points in the second and third dimensions in chronological order by the first dimension.

Dimensionality-reduced feature extraction is performed on the 3D time-frequency joint distribution cubes according to the foregoing formula, to obtain LST-FD joint distribution matrices. A shape of the matrix is (t, Fre_d), where t is the second dimension, that is, the vibration-signal short-time domain dimension, of the original 3D time-frequency joint distribution cube, and Fre_d is a frequency-time domain average difference obtained by the original 3D time-frequency joint distribution cube from the frequency amplitudes based on the first dimension.

In an example embodiment, in the method for determining a mechanical device fault provided in this embodiment of this application, before dividing a plurality of LST-FD joint distribution matrices included in the LST-FD joint distribution matrix set to obtain the training data set and a test data set used for testing the preset neural network model, the method further includes: determining a label type corresponding to the LST-FD joint distribution matrix according to a source data type corresponding to the LST-FD joint distribution matrix, where the label type is either of the fault label and the non-fault label.

As stated above, after the foregoing processing is performed on the source data, pieces of sample data (data subsets) in the source data sets X__{fault}={x__{(f1,)}, x__{(f2,)}, . . . , x__{fi}} and X_ₙₒᵣₘₐₗ={x__{(n1,)}, x__{(n2,)}, . . . , x_ₙᵢ} are processed into LST-FD joint distribution matrix sets having a one-to-one correspondence. In addition, the LST-FD joint distribution matrix generated for the non-fault data and the fault data generates corresponding labeled data sets labeled with 1 and 0 respectively, 1 indicates that the state of the device is faulty, and 0 indicates that the state of the device is normal. The LST-FD joint distribution matrix sets corresponding to normal data and fault data and their respective labeled data are segmented respectively according to a ratio of, e.g., 1:9, to generate a test data set and a training data set.

Further, after the training data set and the test data set are generated, the training data set is input into the foregoing neural network model. After being calculated at layers of the network, the data is output to a next neural network layer through a ReLU activation function, and a Log Softmax function at the last layer outputs a calculation result. The calculation result and real data are input into a CrossEntropyLoss loss function. The loss function calculates a loss value. When the loss value is greater than a set threshold P, an optimization function Adam updates, according to a backpropagation value of the loss value, network connection weights of the layers in a gradient direction toward a direction of reducing the loss value. When the loss value is less than the set threshold P, training of the neural network is ended, a network structure and neuron information of all levels are saved.

The test data set is input into the trained neural network model. A test result and a test accuracy measure, that is, an AUC (Area Under the Curve) value, are output. If the AUC value is less than a set threshold a, testing of the model is considered completed. If the AUC value is greater than the threshold a, resampling is performed to select sample data for performing training and testing of the model again.

In a specific embodiment provided by this application, data of a sensor identified as, eg., AI1-32, in a horizontal direction of an input side of a reduction box of an in-vehicle piston pump of a fracturing vehicle is selected as experimental data, and a sampling frequency of the sensor may be, e.g., 51.2 KHz. The data of the AI1-32 sensor during normal operation of the reduction box may be obtained in a total of 30 hours, and fault data of a bearing roller of the reduction box may be obtained in a total of 18 hours. According to a full rotation period time length of a crankshaft of the device, temporal granularities t2=1 s and t1=10 s are set respectively.

### Training Process

In addition, according to steps 1 to 5, 10800 LST-FD joint distribution matrices of normal data and a same quantity of normal data labels may be generated, and 6480 LST-FD joint distribution matrices of fault data and a same quantity of fault data labels are generated. Sample segmentation is performed according to a ratio of 1:9, to obtain 9720 pieces of normal training data and 9720 labels, 1080 pieces of normal test data and 1080 labels, 5832 pieces of fault training data and 5832 labels, and 648 pieces of fault test data and 648 labels.

Model training and model testing may be performed based on the foregoing example training data and test data, and related example parameters are as follows:

| | |
|---|---|
| Epoch (quantity of times of model training) | 100 |
| Learning rate | 0.0001 |
| Loss value threshold β | 0.01 |
| AUC value threshold α | 0.90 |

Model prediction results and comparison between prediction results of same models directly using a time-frequency graph or a time domain signal statistical indicator as a feature input for fault classification are as follows:

| Method | Accuracy | Loss value | AUC value |
|---|---|---|---|
| LST-FD joint distribution matrix- | 99.53% | 0.0012 | 0.99 |
| based 2D_CNN | | | |
| Time-frequency joint distribution | 97.56% | 0.0034 | 0.97 |
| matrix-based 2D_CNN | | | |
| Time domain statistical indicator- | 92.17% | 0.007 | 0.91 |
| based 2D_CNN | | | |

Therefore, in view of the foregoing specific embodiment, an LST-FD-based 2D_CNN model has the highest prediction accuracy and the highest AUC value, and a time domain statistical indicator-based model has lower prediction accuracy and an AUC value that just exceeds a set threshold.

Therefore, the method for determining a mechanical device fault provided in this application has the following advantages:

1: An LST-FD joint distribution matrix is creatively constructed, and in combination with a preset neural network model, implements device fault prediction with higher prediction accuracy.

2: From a perspective of a device fault occurrence feature, a 3D joint distribution cube including three dimensions, that is, a long-time domain dimension, a short-time domain dimension, and a frequency domain dimension, is constructed. The cube can capture short-time transient spectrum fault features of a fault and long-time deterioration tendency features of the fault, and can detect the fault in an early stage and monitor a deterioration tendency of the fault in a long time.

3: Dimensionality-reduced main feature extraction in the long-time domain dimension is performed on the 3D joint distribution cube to generate an LST-FD joint distribution matrix, which not only retains the original three-dimensional data feature, but also reduces the data dimensionality and improves the prediction accuracy and operation efficiency of the model.

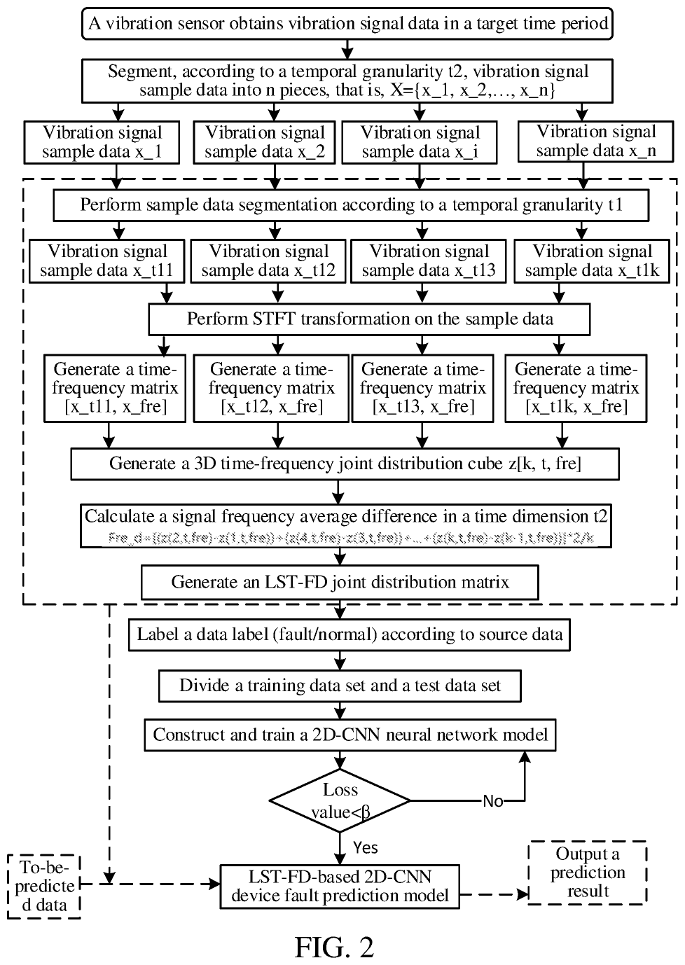

This application further provides another method for determining a mechanical device fault, as shown in FIG. 2. It should be noted that in FIG. 2, t2 is a total time length corresponding to a plurality of full rotation periods corresponding to a mechanical device, and t1 is one full rotation period time length of the device. Through the method provided in FIG. 1, the technical problem that a high-accuracy mechanical device fault detection means is lacked in the related art is resolved, to achieve the technical effect of capturing and reflecting responses of vibration signals to a fault from a plurality of dimensions, so that not only transient features of the fault can be captured, but also long-time deterioration tendency features of the fault can be captured.

It should be noted that steps shown in flowcharts of the accompanying drawings may be performed in a computer system such as a group of computer executable instructions. In addition, although logic sequences are shown in the flowcharts, in some cases, the shown or described steps may be performed in sequences different from those herein.

In a method for determining a mechanical device fault provided in this embodiment of this application, the technical problem that a high-accuracy mechanical device fault detection means is lacking in the related art is resolved through obtaining vibration data corresponding to a target test position of a device and a preset neural network model; inputting the vibration data to the preset neural network model, and obtaining an output result of the preset neural network model; determining a target label included in the output result, where the target label is either of a fault label and a non-fault label; and determining, in a case that the target label is the fault label, that a fault occurs at the target test position; otherwise, determining that the fault does not occur at the target test position, to achieve the technical effect of capturing and reflecting responses of vibration signals to a fault from a plurality of dimensions, so that not only transient features of the fault can be captured, but also long-time deterioration tendency features of the fault can be captured.

It should be noted that steps shown in flowcharts of the accompanying drawings may be performed in a computer system such as a group of computer executable instructions. In addition, although logic sequences are shown in the flowcharts, in some cases, the shown or described steps may be performed in sequences different from those herein.

An embodiment of this application further provides an apparatus for determining a mechanical device fault. It should be noted that the apparatus for determining a mechanical device fault according to this embodiment of this application may be configured to execute the method for determining a mechanical device fault provided in the embodiments of this application. The apparatus for determining a mechanical device fault provided in this embodiment of this application is described below.

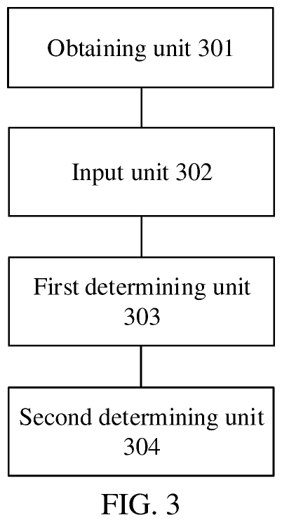

FIG. 3 is a schematic diagram of an apparatus for determining a mechanical device fault according to an embodiment of this application. As shown in FIG. 3, the apparatus includes: an obtaining unit 301, configured to obtain vibration data corresponding to a target test position of a device and a preset neural network model; an input unit 302, configured to input the vibration data to the preset neural network model, and obtain an output result of the preset neural network model; a first determining unit 303, configured to determine a target label included in the output result, where the target label is either of a fault label and a non-fault label; and a second determining unit 304, configured to determine, in a case that the target label is the fault label, that a fault occurs at the target test position; otherwise, determine that the fault does not occur at the target test position.

In an example embodiment, a construction unit is configured to construct an initial preset neural network model before obtaining the preset neural network model, where the initial preset neural network model includes a plurality of convolution layers, a plurality of pooling layers, and a plurality of fully-connected layers, which are connected by a ReLU activation function, and the fully-connected layers are further connected to a Log Softmax function. A third determining unit is configured to determine a training data set used for training the initial preset neural network model, and train the initial preset neural network model based on the training data set to obtain the preset neural network model.

In an example embodiment, the third determining unit includes an obtaining subunit, configured to obtain source data, where the source data is acquired through a vibration sensor arranged on a mechanical device, and the source data is either of fault-type data and non-fault-type data. A construction subunit is configured to construct, according to the source data, a 3D time-frequency joint distribution cube including a preset dimension, where the preset dimension includes at least a long-time domain dimension, a short-time domain dimension, and a frequency domain dimension. An extraction subunit is configured to perform dimensionality-reduced feature extraction on the 3D time-frequency joint distribution cube to obtain an LST-FD joint distribution matrix set. A division subunit is configured to divide a plurality of LST-FD joint distribution matrices included in the LST-FD joint distribution matrix set to obtain the training data set and a test data set used for testing the preset neural network model.

In an example embodiment, the division subunit includes a first determining module, configured to determine a label type corresponding to the LST-FD joint distribution matrix according to a source data type corresponding to the LST-FD joint distribution matrix, where the label type is either of the fault label and the non-fault label.

In an example embodiment, the construction subunit includes a second determining module, configured to determine a first temporal granularity, and perform data segmentation on the source data based on the first temporal granularity to obtain a fault sample data set and a non-fault sample data set, where the fault sample data set includes a plurality of fault data subsets, the non-fault sample data set includes a plurality of non-fault data subsets, and the first temporal granularity includes at least a total time corresponding to a plurality of full rotation periods corresponding to the mechanical device; a third determining module, configured to determine a second temporal granularity; a first segmentation module, configured to segment each fault data subset according to the second temporal granularity to obtain a plurality of pieces of first short-time period data; a second segmentation module, configured to segment each non-fault data subset according to the second temporal granularity to obtain a plurality of pieces of second short-time period data; and a processing module, configured to process the plurality of pieces of first short-time period data corresponding to the fault sample data set and the plurality of pieces of second short-time period data corresponding to the non-fault sample data set, to obtain the 3D time-frequency joint distribution cube.

In an example embodiment, the processing module includes a first processing submodule, configured to perform STFT transformation on the plurality of pieces of first short-time period data to obtain a plurality of first time domain joint distribution matrices; a second processing submodule, configured to perform STFT transformation on the plurality of pieces of second short-time period data to obtain a plurality of second time domain joint distribution matrices; a stacking submodule, configured to stack the plurality of first time domain joint distribution matrices and the plurality of second time domain joint distribution matrices into a time domain joint distribution matrix set according to the first temporal granularity and a preset sequence; and a construction submodule, configured to construct the 3D time-frequency joint distribution cube according to the time domain joint distribution matrix set.

In an example embodiment, the extraction subunit includes an extraction module, configured to perform, based on the long-time domain dimension, dimensionality-reduced feature extraction on the 3D time-frequency joint distribution cube through a formula 1 to obtain the LST-FD joint distribution matrix, where the formula 1 is:

$$Fre\_d = \frac{[ ( z ( 2 , t , fre ) - z ( 1 , t , fre ) ) + … + ( z ( k , t , fre ) - z ( k - 1 , t , fre ) ) ] * 2}{k} ,$$

where z(k,t,fre) is a time-frequency joint distribution matrix in a long-time domain dimension of the k^{th} layer in the 3D time-frequency joint distribution cube, t is the short-time domain dimension corresponding to the 3D time-frequency joint distribution cube, and Fre_d is a frequency-time domain average difference obtained by performing frequency duplication and calculation by the 3D time-frequency joint distribution cube based on the long-time domain dimension.

An apparatus for determining a mechanical device fault provided in this embodiment of this application includes: an obtaining unit 301, configured to obtain vibration data corresponding to a target test position of a device and a preset neural network model; an input unit 302, configured to input the vibration data to the preset neural network model, and obtain an output result of the preset neural network model; a first determining unit 303, configured to determine a target label included in the output result, where the target label is either of a fault label and a non-fault label; and a second determining unit 304, configured to determine, in a case that the target label is the fault label, that a fault occurs at the target test position; otherwise, determine that the fault does not occur at the target test position.

An apparatus for determining a mechanical device fault includes a processor and a memory. The foregoing obtaining unit 201 and the like are all stored in the memory as program units, and the processor executes the program units stored in the memory to implement corresponding functions.

The processor includes a core. The core calls a corresponding program unit from the memory. One or more cores may be arranged. By adjusting core parameters, the technical problem that a high-accuracy mechanical device fault detection means is lacked in the related art is resolved.

The memory may include the following forms of computer-readable media: a non-persistent memory, a random access memory (RAM), and/or a non-volatile memory, or the like, for example, a read-only memory (ROM) or a flash memory (flash RAM), and the memory includes at least one storage chip.

An example embodiment of this application provides a storage medium, having a program stored therein. When executed by a processor, the program implements a method for determining a mechanical device fault.

An embodiment of this application provides a processor. The processor is configured to run a program. When run, the program performs a method for determining a mechanical device fault.

An embodiment of this application provides a device. The device includes a processor, a memory, and a program stored in the memory and executable by the processor. When executing the program, the processor implements the following steps: obtaining vibration data corresponding to a target test position of a device and a preset neural network model; inputting the vibration data to the preset neural network model, and obtaining an output result of the preset neural network model; determining a target label included in the output result, where the target label is either of a fault label and a non-fault label; and determining, in a case that the target label is the fault label, that a fault occurs at the target test position; otherwise, determining that the fault does not occur at the target test position.

In an example embodiment, before the obtaining a preset neural network model, the method further includes: constructing an initial preset neural network model, where the initial preset neural network model includes a plurality of convolution layers, a plurality of pooling layers, and a plurality of fully-connected layers, which are connected by a ReLU activation function, and the fully-connected layers are further connected to a Log Softmax function; and determining a training data set used for training the initial preset neural network model, and training the initial preset neural network model based on the training data set to obtain the preset neural network model.

In an example embodiment, the determining a training data set used for training the initial preset neural network model includes: obtaining source data, where the source data is acquired through a vibration sensor arranged on a mechanical device, and the source data is either of fault-type data and non-fault-type data; constructing, according to the source data, a 3D time-frequency joint distribution cube including a preset dimension, where the preset dimension includes at least a long-time domain dimension, a short-time domain dimension, and a frequency domain dimension; performing dimensionality-reduced feature extraction on the 3D time-frequency joint distribution cube to obtain an LST-FD joint distribution matrix set; and dividing a plurality of LST-FD joint distribution matrices included in the LST-FD joint distribution matrix set to obtain the training data set and a test data set used for testing the preset neural network model.

In an example embodiment, before the dividing a plurality of LST-FD joint distribution matrices included in the LST-FD joint distribution matrix set to obtain the training data set and a test data set used for testing the preset neural network model, the method further includes: determining a label type corresponding to the LST-FD joint distribution matrix according to a source data type corresponding to the LST-FD joint distribution matrix, where the label type is either of the fault label and the non-fault label.

In an example embodiment, the constructing, according to the source data, a 3D time-frequency joint distribution cube including a preset dimension includes: determining a first temporal granularity, and performing data segmentation on the source data based on the first temporal granularity to obtain a fault sample data set and a non-fault sample data set, where the fault sample data set includes a plurality of fault data subsets, the non-fault sample data set includes a plurality of non-fault data subsets, and the first temporal granularity includes at least a total time corresponding to a plurality of full rotation periods corresponding to the mechanical device; determining a second temporal granularity; segmenting each fault data subset according to the second temporal granularity to obtain a plurality of pieces of first short-time period data; segmenting each non-fault data subset according to the second temporal granularity to obtain a plurality of pieces of second short-time period data; and processing the plurality of pieces of first short-time period data corresponding to the fault sample data set and the plurality of pieces of second short-time period data corresponding to the non-fault sample data set, to obtain the 3D time-frequency joint distribution cube.

In an example embodiment, the processing the plurality of pieces of first short-time period data corresponding to the fault sample data set and the plurality of pieces of second short-time period data corresponding to the non-fault sample data set, to obtain the 3D time-frequency joint distribution cube, includes: performing STFT transformation on the plurality of pieces of first short-time period data to obtain a plurality of first time domain joint distribution matrices; performing STFT transformation on the plurality of pieces of second short-time period data to obtain a plurality of second time domain joint distribution matrices; stacking the plurality of first time domain joint distribution matrices and the plurality of second time domain joint distribution matrices into a time domain joint distribution matrix set according to the first temporal granularity and a preset sequence; and constructing the 3D time-frequency joint distribution cube according to the time domain joint distribution matrix set.

In an example embodiment, the performing dimensionality-reduced feature extraction on the 3D time-frequency joint distribution cube to obtain an LST-FD joint distribution matrix set includes: performing, based on the long-time domain dimension, dimensionality-reduced feature extraction on the 3D time-frequency joint distribution cube through a formula 1 to obtain the LST-FD joint distribution matrix, where the formula 1 is:

$$Fre\_d = \frac{[ ( z ( 2 , t , fre ) - z ( 1 , t , fre ) ) + … + ( z ( k , t , fre ) - z ( k - 1 , t , fre ) ) ] * 2}{k} ,$$

where z(k,t,fre) is a time-frequency joint distribution matrix in a long-time domain dimension of the k^{th} layer in the 3D time-frequency joint distribution cube, t is the short-time domain dimension corresponding to the 3D time-frequency joint distribution cube, and Fre_d is a frequency-time domain average difference obtained by performing frequency duplication and calculation by the 3D time-frequency joint distribution cube based on the long-time domain dimension.

The device herein may be a server, a PC, a PAD, a mobile phone, or the like.

This application further provides a computer program product. When executed on a data processing device, the computer program product is adapted to execute a program initialized with the following method steps: obtaining vibration data corresponding to a target test position of a device and a preset neural network model; inputting the vibration data to the preset neural network model, and obtaining an output result of the preset neural network model; determining a target label included in the output result, where the target label is either of a fault label and a non-fault label; and determining, in a case that the target label is the fault label, that a fault occurs at the target test position; otherwise, determining that the fault does not occur at the target test position.

In an example embodiment, before the obtaining a preset neural network model, the method further includes: constructing an initial preset neural network model, where the initial preset neural network model includes a plurality of convolution layers, a plurality of pooling layers, and a plurality of fully-connected layers, neural network layers are connected by a ReLU activation function, and the fully-connected layers connected to the initial preset neural network model are connected to a Log Softmax function; and determining a training data set used for training the initial preset neural network model, and training the initial preset neural network model based on the training data set to obtain the preset neural network model.

In an example embodiment, the determining a training data set used for training the initial preset neural network model includes: obtaining source data, where the source data is acquired through a vibration sensor arranged on a mechanical device, and the source data is either of fault-type data and non-fault-type data; constructing, according to the source data, a 3D time-frequency joint distribution cube including a preset dimension, where the preset dimension includes at least a long-time domain dimension, a short-time domain dimension, and a frequency domain dimension; performing dimensionality-reduced feature extraction on the 3D time-frequency joint distribution cube to obtain an LST-FD joint distribution matrix set; and dividing a plurality of LST-FD joint distribution matrices included in the LST-FD joint distribution matrix set to obtain the training data set and a test data set used for testing the preset neural network model.

In an example embodiment, before the dividing a plurality of LST-FD joint distribution matrices included in the LST-FD joint distribution matrix set to obtain the training data set and a test data set used for testing the preset neural network model, the method further includes: determining a label type corresponding to the LST-FD joint distribution matrix according to a source data type corresponding to the LST-FD joint distribution matrix, where the label type is either of the fault label and the non-fault label.

In an example embodiment, the constructing, according to the source data, a 3D time-frequency joint distribution cube including a preset dimension includes: determining a first temporal granularity, and performing data segmentation on the source data based on the first temporal granularity to obtain a fault sample data set and a non-fault sample data set, where the fault sample data set includes a plurality of fault data subsets, the non-fault sample data set includes a plurality of non-fault data subsets, and the first temporal granularity includes at least a total time corresponding to a plurality of full rotation periods corresponding to the mechanical device; determining a second temporal granularity; segmenting each fault data subset according to the second temporal granularity to obtain a plurality of pieces of first short-time period data; segmenting each non-fault data subset according to the second temporal granularity to obtain a plurality of pieces of second short-time period data; and processing the plurality of pieces of first short-time period data corresponding to the fault sample data set and the plurality of pieces of second short-time period data corresponding to the non-fault sample data set, to obtain the 3D time-frequency joint distribution cube.

In an example embodiment, the processing the plurality of pieces of first short-time period data corresponding to the fault sample data set and the plurality of pieces of second short-time period data corresponding to the non-fault sample data set, to obtain the 3D time-frequency joint distribution cube, includes: performing STFT transformation on the plurality of pieces of first short-time period data to obtain a plurality of first time domain joint distribution matrices; performing STFT transformation on the plurality of pieces of second short-time period data to obtain a plurality of second time domain joint distribution matrices; stacking the plurality of first time domain joint distribution matrices and the plurality of second time domain joint distribution matrices into a time domain joint distribution matrix set according to the first temporal granularity and a preset sequence; and constructing the 3D time-frequency joint distribution cube according to the time domain joint distribution matrix set.

In an example embodiment, the performing dimensionality-reduced feature extraction on the 3D time-frequency joint distribution cube to obtain an LST-FD joint distribution matrix set includes: performing, based on the long-time domain dimension, dimensionality-reduced feature extraction on the 3D time-frequency joint distribution cube through a formula 1 to obtain the LST-FD joint distribution matrix, where the formula 1 is:

$$Fre\_d = \frac{[ ( z ( 2 , t , fre ) - z ( 1 , t , fre ) ) + … + ( z ( k , t , fre ) - z ( k - 1 , t , fre ) ) ] * 2}{k} ,$$

where z(k,t,fre) is a time-frequency joint distribution matrix in a long-time domain dimension of the k^{th} layer in the 3D time-frequency joint distribution cube, t is the short-time domain dimension corresponding to the 3D time-frequency joint distribution cube, and Fre_d is a frequency-time domain average difference obtained by performing frequency duplication and calculation by the 3D time-frequency joint distribution cube based on the long-time domain dimension.

A person skilled in the art should understand that embodiments of this application may be provided as a method, a system, or a computer program product. Therefore, this application may use a form of hardware only embodiments, software only embodiments, or embodiments with a combination of software and hardware. In addition, in this application, a form of a computer program product that is implemented on one or more computer-usable storage media (including, but not limited to, a disk memory, a CD-ROM, an optical memory, and the like) that include computer-usable program code may be used.

This application is described with reference to the flowcharts and/or block diagrams of the method, the device (system), and the computer program product according to embodiments of this application. It should be understood that computer program instructions may be used to implement each process and/or each block in the flowcharts and/or the block diagrams and a combination of a process and/or a block in the flowcharts and/or the block diagrams. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory may include the following forms of computer-readable media: a non-persistent memory, a random access memory (RAM), and/or a non-volatile memory, or the like, for example, a read-only memory (ROM) or a flash memory (flash RAM). The memory is an example of the computer-readable medium.

The computer-readable medium includes a non-volatile medium and a volatile medium, a movable medium and a non-movable medium, which may implement storage of information by using any method or technology. The information may be a computer-readable instruction, a data structure, a program module, or other data. Examples of a computer storage medium include but are not limited to a phase-change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette tape, a magnetic tape, a magnetic disk storage or other magnetic storage device, or any other non-transmission medium, which may be configured to store information accessible by a computing device. Based on the description in this application, the computer-readable medium does not include transitory computer-readable media (transitory media), such as a modulated data signal and a carrier.

It should also be noted that the terms “include”, “comprise”, or any variants thereof are intended to cover a non-exclusive inclusion. Therefore, a process, method, article, or device that includes a series of elements not only includes such elements, but also includes other elements not specified expressly, or may include inherent elements of the process, method, article, or device. Without further limitation, the element defined by a phrase “include one . . . ” does not exclude other same elements in the process, method, article, or device that includes the element.

A person skilled in the art should understand that embodiments of this application may be provided as a method, a system, or a computer program product. Therefore, this application may use a form of hardware only embodiments, software only embodiments, or embodiments with a combination of software and hardware. In addition, in this application, a form of a computer program product that is implemented on one or more computer-usable storage media (including, but not limited to, a disk memory, a CD-ROM, an optical memory, and the like) that include computer-usable program code may be used.

The foregoing descriptions are merely embodiments of this application and are not intended to limit this application. For a person skilled in the art, various modifications and variations can be made to this application. Any modification, equivalent replacement, or improvement made without departing from the spirit and principle of this application shall fall within the scope of the claims of this application.

What is claimed is:

1. A method for determining a mechanical device fault, comprising:
obtaining vibration data corresponding to a target test position of a mechanical device and a pre-trained neural network model, the vibration data being taken from a sensor installed at the target test position;
segmenting and transforming the vibration data into a processed vibration data comprising a 3D time-frequency joint distribution cube having a long-time domain dimension, a short-time domain dimension, and a frequency domain dimension;
inputting the processed vibration data to the pre-trained neural network model, and obtaining an output result from the pre-trained neural network model;
determining a target label comprised in the output result, wherein the target label is either of a fault label and a non-fault label; and
determining, when the target label is of the fault label, that a fault has occurred at the target test position, otherwise determining that the fault has not occurred at the target test position.

2. The method according to claim 1, wherein before obtaining the pre-trained neural network model, the method further comprises:
constructing an initial neural network model, wherein the initial neural network model comprises a plurality of convolution layers, a plurality of pooling layers, and a plurality of fully-connected layers, which are connected by a ReLU activation function, and the fully-connected layers connected to the initial neural network model are connected to a Log Softmax function; and
determining a training data set used for training the initial neural network model, and training the initial neural network model based on the training data set to obtain the pre-trained neural network model.

3. The method according to claim 2, wherein determining the training data set used for training the initial neural network model comprises:
obtaining source data, wherein the source data is acquired through one or more vibration sensors arranged on a mechanical device, and the source data are either of fault-type data and non-fault-type data;
performing dimensionality-reduction feature extraction on the 3D time-frequency joint distribution cube to obtain a long short time-frequency difference (LST-FD) joint distribution matrix set; and
dividing a plurality of LST-FD joint distribution matrices comprised in the LST-FD joint distribution matrix set to obtain the training data set and a test data set used for training and testing the initial neural network model to obtain the pre-trained neural network model.

4. The method according to claim 3, wherein before dividing the plurality of LST-FD joint distribution matrices comprised in the LST-FD joint distribution matrix set to obtain the training data set and the test data set, the method further comprises:
determining a label type corresponding to the LST-FD joint distribution matrix according to a source data type corresponding to the LST-FD joint distribution matrix, wherein the label type is either of the fault label and the non-fault label.

5. The method according to claim 3, wherein constructing, according to the source data, the 3D time-frequency joint distribution cube comprises:
determining a first temporal granularity, and performing data segmentation on the source data based on the first temporal granularity to obtain a fault sample data set and a non-fault sample data set, wherein the fault sample data set comprises a plurality of fault data subsets, the non-fault sample data set comprises a plurality of non-fault data subsets, and the first temporal granularity comprises at least a total time corresponding to a plurality of full rotation periods corresponding to the mechanical device;
determining a second temporal granularity;
segmenting each fault data subset according to the second temporal granularity to obtain a plurality of pieces of first short-time period data;
segmenting each non-fault data subset according to the second temporal granularity to obtain a plurality of pieces of second short-time period data; and
processing the plurality of pieces of first short-time period data corresponding to the fault sample data set and the plurality of pieces of second short-time period data corresponding to the non-fault sample data set, to obtain the 3D time-frequency joint distribution cube.

6. The method according to claim 5, wherein processing the plurality of pieces of first short-time period data corresponding to the fault sample data set and the plurality of pieces of second short-time period data corresponding to the non-fault sample data set, to obtain the 3D time-frequency joint distribution cube, comprises:
performing STFT transformation on the plurality of pieces of first short-time period data to obtain a plurality of first time domain joint distribution matrices;
performing STFT transformation on the plurality of pieces of second short-time period data to obtain a plurality of second time domain joint distribution matrices;
stacking the plurality of first time domain joint distribution matrices and the plurality of second time domain joint distribution matrices into a time domain joint distribution matrix set according to the first temporal granularity and a preset sequence; and
constructing the 3D time-frequency joint distribution cube according to the time domain joint distribution matrix set.

7. The method according to claim 3, wherein performing the dimensionality-reduction feature extraction on the 3D time-frequency joint distribution cube to obtain an LST-FD joint distribution matrix set comprises:
performing, based on the long-time domain dimension, the dimensionality-reduction feature extraction on the 3D time-frequency joint distribution cube to obtain the LST-FD joint distribution matrix, via a formula of:
$$Fre\_d = \frac{[ ( z ( 2 , t , fre ) - z ( 1 , t , fre ) ) + … + ( z ( k , t , fre ) - z ( k - 1 , t , fre ) ) ] * 2}{k} ,$$
wherein z(k,t,fre) is a time-frequency joint distribution matrix in the long-time domain dimension of the k^{th} layer in the 3D time-frequency joint distribution cube, t is the short-time domain dimension corresponding to the 3D time-frequency joint distribution cube, and Fre_d is a frequency-time domain average difference obtained by performing frequency duplication and calculation by the 3D time-frequency joint distribution cube based on the long-time domain dimension.

8. The method according to claim 1, wherein the pre-trained neural network model is a 2D-CNN neural network model.

9. An apparatus for determining a mechanical device fault, comprising vibrational sensor installed in a mechanical device, a circuitry electrically connected to the vibrational sensor and configured to:
obtain vibration data corresponding to a target test position of the mechanical device and a pre-trained neural network model, the vibration data being taken from the vibrational sensor being installed at the target test position;
segment and transform the vibration data into a processed vibration data comprising a 3D time-frequency joint distribution cube having a long-time domain dimension, a short-time domain dimension, and a frequency domain;
input the processed vibration data to the pre-trained neural network model, and obtain an output result from the pre-trained neural network model;
determine a target label comprised in the output result, wherein the target label is either of a fault label and a non-fault label; and
determine, when he target label is of the fault label, that a fault has occurred at the target test position; otherwise, determine that the fault has not occurred at the target test position.

10. The apparatus of claim 9, wherein the circuitry, before obtaining the pre-trained neural network model, is further configured to:
construct an initial neural network model, wherein the initial neural network model comprises a plurality of convolution layers, a plurality of pooling layers, and a plurality of fully-connected layers, which are connected by a ReLU activation function, and the fully-connected layers connected to the initial neural network model are connected to a Log Softmax function; and
determine a training data set used for training the initial neural network model, and training the initial neural network model based on the training data set to obtain the pre-trained neural network model.

11. The apparatus of claim 10, wherein the circuitry is configured to determine the training data set used for training the initial neural network model by:
obtaining source data, wherein the source data is acquired through one or more vibration sensors arranged on a mechanical device, and the source data are either of fault-type data and non-fault-type data;
performing dimensionality-reduction feature extraction on the 3D time-frequency joint distribution cube to obtain a long short time-frequency difference (LST-FD) joint distribution matrix set; and
dividing a plurality of LST-FD joint distribution matrices comprised in the LST-FD joint distribution matrix set to obtain the training data set and a test data set used for training and testing the initial neural network model to obtain the pre-trained neural network model.

12. The apparatus of claim 11, wherein, before dividing the plurality of LST-FD joint distribution matrices comprised in the LST-FD joint distribution matrix set to obtain the training data set and the test data set, the circuitry is further configured to:
determine a label type corresponding to the LST-FD joint distribution matrix according to a source data type corresponding to the LST-FD joint distribution matrix, wherein the label type is either of the fault label and the non-fault label.

13. The apparatus of claim 11, wherein the circuitry is configured to construct the 3D time-frequency joint distribution cube by:
determining a first temporal granularity, and performing data segmentation on the source data based on the first temporal granularity to obtain a fault sample data set and a non-fault sample data set, wherein the fault sample data set comprises a plurality of fault data subsets, the non-fault sample data set comprises a plurality of non-fault data subsets, and the first temporal granularity comprises at least a total time corresponding to a plurality of full rotation periods corresponding to the mechanical device;
determining a second temporal granularity;
segmenting each fault data subset according to the second temporal granularity to obtain a plurality of pieces of first short-time period data;
segmenting each non-fault data subset according to the second temporal granularity to obtain a plurality of pieces of second short-time period data; and
processing the plurality of pieces of first short-time period data corresponding to the fault sample data set and the plurality of pieces of second short-time period data corresponding to the non-fault sample data set, to obtain the 3D time-frequency joint distribution cube.

14. The apparatus of claim 13, wherein the circuitry is configured to process the plurality of pieces of first short-time period data and the plurality of pieces of second short-time period data to obtain the 3D time-frequency joint distribution cube by:
performing STFT transformation on the plurality of pieces of first short-time period data to obtain a plurality of first time domain joint distribution matrices;
performing STFT transformation on the plurality of pieces of second short-time period data to obtain a plurality of second time domain joint distribution matrices;
stacking the plurality of first time domain joint distribution matrices and the plurality of second time domain joint distribution matrices into a time domain joint distribution matrix set according to the first temporal granularity and a preset sequence; and
constructing the 3D time-frequency joint distribution cube according to the time domain joint distribution matrix set.

15. The apparatus according to claim 11, wherein the circuitry is configured to perform the dimensionality-reduction feature extraction on the 3D time-frequency joint distribution cube to obtain an LST-FD joint distribution matrix set by:
performing, based on the long-time domain dimension, the dimensionality-reduction feature extraction on the 3D time-frequency joint distribution cube to obtain the LST-FD joint distribution matrix, via a formula of:
$$Fre\_d = \frac{[ ( z ( 2 , t , fre ) - z ( 1 , t , fre ) ) + … + ( z ( k , t , fre ) - z ( k - 1 , t , fre ) ) ] * 2}{k} ,$$
wherein z(k,t,fre) is a time-frequency joint distribution matrix in the long-time domain dimension of the k^{th} layer in the 3D time-frequency joint distribution cube, t is the short-time domain dimension corresponding to the 3D time-frequency joint distribution cube, and Fre_d is a frequency-time domain average difference obtained by performing frequency duplication and calculation by the 3D time-frequency joint distribution cube based on the long-time domain dimension.

16. The apparatus of claim 9, wherein the pre-trained neural network model is a 2D-CNN neural network model.

17. A non-transitory computer-readable storage medium, comprising a stored program, wherein the stored program, when being executed by a processor, is configured to determine a mechanical device fault according to claim 1.

18. A processor, configured to run a computer program, to detect a mechanical device fault according to claim 1.
